(19) United States
(12) Patent Application Publication
(10) Pub. No.: US 2011/0106691 A1
(43) Pub. Date: May 5, 2011

(54) SYSTEMS AND METHODS FOR TRACKING FINANCIAL INFORMATION

(76) Inventors: D. Sean Clark, Provo, UT (US); Watson LeGrand Ellison, Springville, UT (US); Jason Borup, Orem, UT (US); Seth Risenmay, Provo, UT (US)

(21) Appl. No.: 12/793,450

(22) Filed: Jun. 3, 2010

Related U.S. Application Data
(60) Provisional application No. 61/183,922, filed on Jun. 3, 2009.

(51) Int. Cl. G06Q 40/00

(52) U.S. Cl. 705/38; 705/36 R

(57) ABSTRACT

Embodiments include systems and methods for assisting with financial planning. In one embodiment, a financial planning system generates a convenient user interface that displays a variety of financial information in an easy to understand format. In one embodiment, a financial planning system aggregates data from multiple sources and displays the data in a manner that is useful for financial planning, such as debt, retirement, and budget planning. In another embodiment, the financial planning system promotes financial services and products.

### CROSS-REFERENCE TO RELATED APPLICATIONS

The present application claims the benefit of U.S. Provisional Patent Application Ser. No. 61/183,922, filed on Jun. 3, 2009, which is hereby incorporated by reference in its entirety.

### BACKGROUND OF THE INVENTION

1. Field of the Invention

The developed embodiments relate to systems and methods for automated assistance with financial planning.

2. Description of the Related Art

Making smart financial decisions based on income, expenses, and investments from various sources is a difficult process. Normally, a user seeking to make sound financial decisions must attempt to understand and coordinate individual bank accounts, savings and retirement accounts, credit and loan accounts, all of which normally are formatted differently, accessed separately, and difficult to understand individually, much less collectively. Thus, it is desirable to have a convenient user interface that can combine and display a variety of financial information in an easy to understand format. In addition, it is advantageous to have a system that combines financial data in a manner that projects the consequences of possible financial decisions based on financial data retrieved from multiple sources.

### SUMMARY OF THE INVENTION

The systems, methods, and devices of the development each have several aspects, no single one of which is solely responsible for its desirable attributes. Without limiting the scope of the development as expressed by the claims which follow, its more prominent features will now be discussed briefly. After considering this discussion, and particularly after reading the section entitled “Detailed Description of Certain Embodiments” one will understand how the features of the development provide advantages that include greater security and efficiency for updating data stores.

In one embodiment, a system for managing financial information, comprises a processor configured to: receive data associated with a plurality of financial accounts, process the data, wherein processing comprises one of categorizing, summarizing, or aggregating, and generate an interface displaying the processed data. In another embodiment, a method for managing financial information, comprises receiving data associated with a plurality of financial accounts, processing the data, wherein processing comprises one of categorizing, summarizing, or aggregating, and generating an interface displaying the processed data. In another embodiment, a system for managing financial information, comprises means for receiving data associated with a plurality of financial accounts, means for processing the data, wherein processing comprises one of categorizing, summarizing, or aggregating, and means for generating an interface displaying the processed data.

Some embodiments relate to systems for managing financial information. The systems can include, for example, a processor configured to receive data associated with a plurality of financial accounts; process the data, wherein processing comprises one of categorizing, summarizing, or aggregating; and generate an interface displaying the processed data.

The receiving data associated with a plurality of financial accounts may include, for example, receiving login information associated with a plurality of accounts; and retrieving data from the plurality of financial accounts using the login information. The receiving data associated with a plurality of financial accounts can include, for example, receiving information from a financial institution. The method for processing the data may be, for example, dependent on the source of the financial information.

The processor further may be configured to, for example, receive user input categorizing expenses and income into a budget; receive actual expenses and income; reconcile the actual expenses and income with the categorized expenses and income; and generate an interface for displaying the reconciled expenses and income. The processor further can be configured to calculate a projected payoff forecast for a debt; and generate an interface for displaying the calculated projected payoff, for example. The processor further may be configured to determine options for restructuring or refinancing a debt; and generate an interface for displaying the determined options for restructuring or refinancing the debt, for example. The processor further can be configured to, for example, receive input listing the order in which to payoff debts; determine the amount of money saved on interest based on the order of payoff; generate an interface for displaying the determined amount of money saved; and generate an interface for displaying options for using the money saved. The processor may be further configured to retrieve a credit score; and generate an interface for displaying the credit score, for example. The processor further may be configured to identify credit repair information; and generate an interface for displaying information about repairing the credit score. The processor further can be configured to determine one or more strategic offers based on the credit score; and generate an interface for presenting one or more strategic offers. The processor may be further configured to identify affiliate partners to help improve a credit score; and generate an interface for displaying the affiliate partners. The processor further may be configured to provide rewards based on use of the system; and generate an interface for displaying the provided rewards. The processor further may be configured to receive information relevant to identity theft; and generate an interface for displaying information about protection from identity theft based on the received information. The processor is further configured to receive information about finances saved for retirement; generate an interface for displaying the finances saved for retirement; determine options for managing the finances saved for retirement; and generate an interface for displaying options for managing the finances saved for retirement. The processor further can be configured to calculate whether a user will have a surplus or deficit at multiple future points in time; and generate an interface for displaying a timeline of whether a user will have a surplus or deficit at each point on the timeline. The processor may be further configured to receive information about a financial scenario; calculate the financial consequences of the received scenario; and generate an interface for displaying the financial consequences of the received financial scenario. In some embodiments the processor can be configured to include one or more of the functions or actions listed above, including in any combination or order. In some embodiments, the processor can be configured to expressly exclude one or more of the above listed functions or actions.

Some embodiments relate to methods for managing financial information. The methods can include, for example, receiving data associated with a plurality of financial accounts; processing the data, wherein processing comprises one of categorizing, summarizing, or aggregating; and generating an interface displaying the processed data.

The receiving data associated with a plurality of financial accounts may include, for example, receiving login information associated with a plurality of accounts; and retrieving data from the plurality of financial accounts using the login information. The receiving data associated with a plurality of financial accounts may include, for example, receiving information from a financial institution.

Some embodiments relate to systems for managing financial information. The systems may include, for example, means for receiving data associated with a plurality of financial accounts; means for processing the data, wherein processing comprises one of categorizing, summarizing, or aggregating; and means for generating an interface displaying the processed data. The receiving data associated with a plurality of financial accounts may include, for example, means for receiving login information associated with a plurality of accounts; and means for retrieving data from the plurality of financial accounts using the login information. The receiving data associated with a plurality of financial accounts may include, for example, receiving information from a financial institution.

### BRIEF DESCRIPTION OF THE DRAWINGS

FIG. 1 is a block diagram illustrating one embodiment of a financial planning system.

FIG. 2 is a flow diagram illustrating a financial planning process.

FIG. 3 is a block diagram illustrating the modules of a financial planning system.

FIG. 4 is a block diagram illustrating financial planning analysis sub-modules FIG. 4 is a flow diagram illustrating the financial information tracking module.

FIG. 5 is a flow diagram illustrating a budget analysis process.

FIG. 6 is a flow diagram illustrating a debt management analysis processes.

FIG. 7 is a flow diagram illustrating a credit score analysis.

FIG. 8 is a flow diagram illustrating a retirement analysis process.

FIG. 9 is a flow diagram illustrating an identity theft analysis process.

FIG. 10 is a flow diagram illustrating a rewards process.

FIG. 11 is a flow diagram illustrating a financial projections process.

FIG. 12 is a flow diagram illustrating a financial scenarios process.

### DETAILED DESCRIPTION OF THE PREFERRED EMBODIMENT

The following detailed description is directed to certain specific embodiments of the development. However, the development can be embodied in a multitude of different ways as defined and covered by the claims. In this description, reference is made to the drawings wherein like parts are designated with like numerals throughout.

The methods, systems and devices described herein can provide for financial clarity, debt management and elimination, financial control, and the ability to make proactive financial decisions, for example. In some embodiments the methods, systems and devices can make it easier for a user to manage his/her money, such that he/she will never put it off again. The methods, systems and devices can automatically download, categorize and report monthly budget and spending, which can permit the user to know his/her financial situation at any given time.

Some embodiments relate to methods, systems and devices for debt management and elimination. The methods, systems and devices can permit a user to get out of debt faster. The methods, systems and devices permit a user to make interest work more in favor of the user. For example, in some embodiments the methods, systems and devices can teach how to use interest more in favor of the user, rather than exclusively in favor of the bank. The methods, systems and devices can provide, teach and show a few easy-to-follow steps or instructions that can get a user out of debt faster. Based on the user's existing spending patterns and income, the methods and system can create a debt elimination plan with detailed projections and step-by-step instructions that change and adapt as the user's financial situation changes. These instructions can be delivered to the user, for example, through the debt management interface, email, and phone, including text messaging. The methods, systems and devices can help a user take years off his/her mortgage and save thousands in interest. In some embodiments the methods, systems and devices permit a user to more quickly bring credit card balances down to zero and/or to get back on track to build up his/her retirement. In some aspects the methods, systems and devices provide tools to show a user how paying off debt, or taking on more of it, will affect long term financial and retirement goals.

Also, some embodiments relate to methods, systems and devices for greater financial clarity. The methods, systems and devices can show a user many or all the user's various accounts together, for example, side by side, to give the user a clear idea of the shape of his/her finances. The methods, systems and devices can further include interactive tools to break down the financial information and analyze spending to give the clearest, most complete picture of a user's financial accounts. In some aspects the methods and systems can provide real-time reporting to assist a user to stay within budget and see where every penny goes. Real-time reporting may allow a user to see their projected debt, budget, etc. at that exact moment. The methods and systems can further update and adapt depending on the user's current financial situation. For example, if a user's disposable income changed over time the user's financial projections would reflect the user's current financial situation and disposable income. The methods and systems also can identify long-term financial wellness by showing clear and detailed information about payoff forecasts, retirement funds, and savings. The methods and systems can permit a user to see today's spending in the context of long-term wealth accumulation and to watch how even small changes today can affect the lifetime of loans and savings.

Furthermore, some embodiments relate to methods and systems for greater financial control. The methods and systems permit a user to take charge of his/her financial future. The methods and systems can include the resources that empower a user to reach additional financial goals. The methods and systems can permit a user's financial plan to be customized to fit the specific user needs and lifestyle, so he/she can plan for the future and make the most of today. In some aspects, the methods and systems provide tools to help manage a user's credit score, find interest-saving loans and credit cards, and proactively manage long-term wealth—all in one, easy-to-use system or device.

Also, some embodiments relate to methods and systems for making proactive financial decisions. The methods and systems help a user make the best financial decisions possible. If a user is thinking about buying a home or a car, then in some aspects the methods and systems can provide information, graphics, and displays that show how those decisions can affect lifetime wealth by comparing current budget, payoff, and retirement numbers with a scenario a user specifies. The methods and systems permit a user to see how purchases may affect lifetime wealth, and they can provide the user with the information needed to make smart, well-informed decisions that will benefit long-term financial goals.

In one embodiment, a financial tracking system can integrate into a single system features for budgeting, interest savings, debt elimination, retirement planning, online shopping, and strategic savings. The financial tracking system may include features for managing personal finances, such as account aggregation (displaying multiple accounts in a single interface), budgeting tools, credit score tracking, expense tracking, debt elimination, financial IQ decision making tools, and strategic savings tools. The strategic savings tools may be based on the users actual spending and financial situation. In one embodiment, the financial tracking system is a personal finance solution, institutional sales tool, and revenue sharing platform. Use of the financial tracking system may enable liquidity, financial freedom, and wealth.

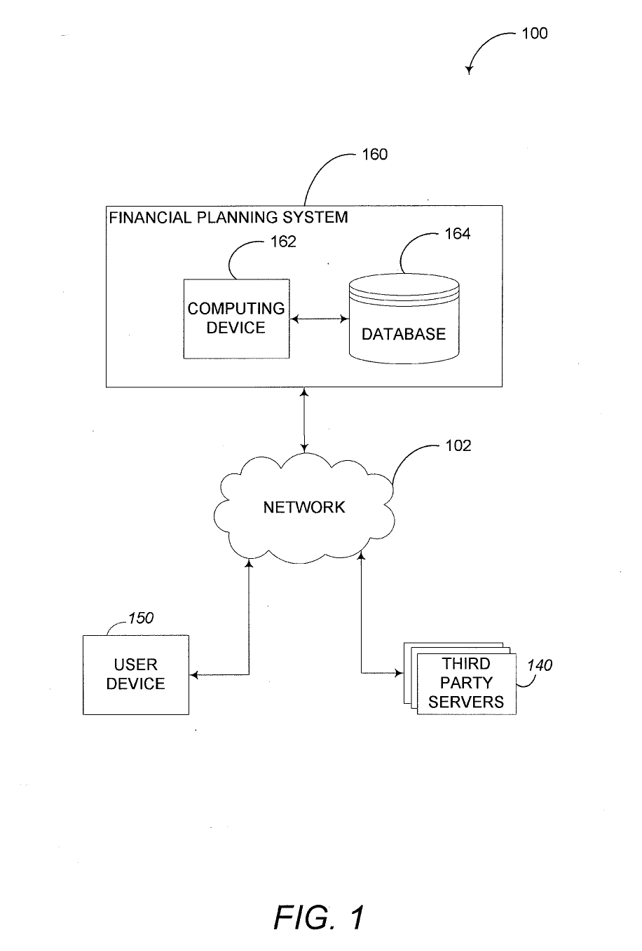

FIG. 1 is a block diagram of a financial planning environment 100 featuring a user device 150, a network 102, a financial planning system 160, and one or more third party servers 140. The user device 150 may be any suitable computing device. For example, the user device 150 can be any of numerous general purpose or special purpose computing system environments or configurations. Examples of well known computing devices, systems, environments, and/or configurations that may be suitable for use with the embodiments include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like. Accordingly, one or more aspects taught herein may be incorporated into a phone (e.g., a cellular phone or smart phone (iPhone® or phones running the Android® operating system), a computer (e.g., a laptop or a mini laptop), a portable communication device (including without being limited thereto, devices such as iPads® and “tablet” computing devices), a portable computing device (e.g., a personal data assistant), an entertainment device (e.g., a music or video device, or a satellite radio (e.g., mp3 player, iPod®, etc.), a global positioning system device, or any other suitable device that is configured to communicate via a wireless or wired medium. The network 102 may be any suitable type of network. In one embodiment, the network 102 is the Internet. In another embodiment, the network 102 is a local area network (LAN) or a wide area network (WAN). The financial planning system 160 includes a computing device 162 and a database 164. The financial planning system 160 may be embodied in a single or multiple server configuration. In one embodiment, the database 164 is a relational database. In another embodiment, the database 164 stores data in a fixed file format, such as XML, comma separated values, tab separated values, or fixed length fields. In one embodiment, the third party server 140 is a server of a single third party. In another embodiment, there are multiple third party servers 140. In one embodiment, the third party servers 140 are operated by an entity other than the user of the user device 150 or the owner of the financial planning system 160. For example, the third party servers 140 could be operated by financial institutions, credit agencies, affiliates, or vendors. The user device 150, financial planning system 160, and third party server 140 communicate with each other via the network 102.

In one embodiment, the financial planning system 160 processes and displays financial information for an individual or group. In one embodiment, the financial planning system 160 requires a login and registration process in order to link financial information to a particular user. If the user is an existing user, the financial planning system 160 proceeds to execute a login process. In one embodiment, the login process receives credentials input through the user device 150. The login process may then utilize the received credentials to determine whether to grant access to the system. In another embodiment, the login process can receive biometrics, symmetric or asymmetric keys, or other information to determine whether to grant access. If the user is a new user, the financial planning system 160 proceeds to execute a registration process. In one embodiment, the registration process generates an interface for receiving a variety of data from a user device 150, such as identification information, contact information, demographic information, disabilities, display preferences, and preferred language. After successfully completing the registration process, the financial planning system 160 may advance to the login process. A “user” as referred to herein may refer to a user account, which may be an account for an individual, business, or other entity.

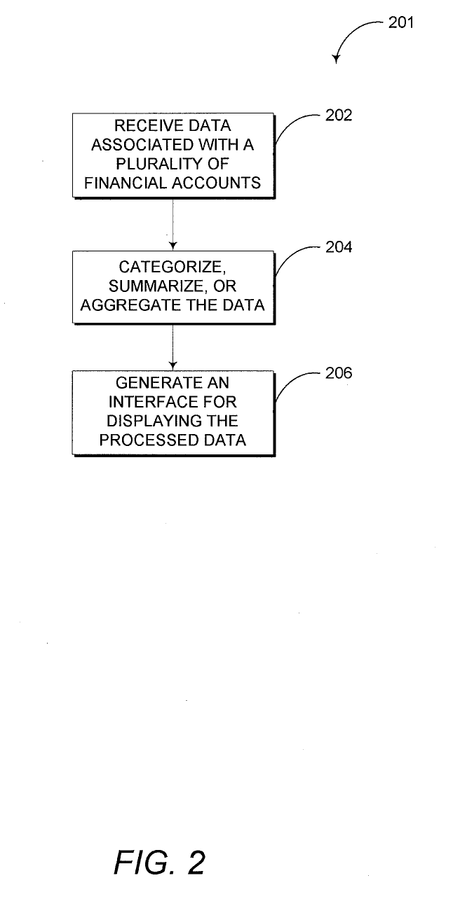

FIG. 2 is a flow diagram illustrating financial planning process 201. Beginning at a block 202, the financial planning system 160 receives data associated with a plurality of financial accounts. The various sources may include, for example, banking, mortgage, lines of credit, credit card, retirement account, and other financial sources. In one embodiment, the financial planning system 160 generates an interface for receiving information about a user's finances. The information may include, for example, salary, account, income, and debt information. In one embodiment, the user's account information includes a schedule dictating how often to update information about the account. In one embodiment, the financial planning system 160 receives information about multiple financial accounts. The financial planning system 160 may further receive other information, such as debt payoff order, tax information, customer rewards program information, debt information, disability or employment status, and display preferences. The financial planning system 160 may generate an interface to allow a user to add, delete, or merge accounts.

In another embodiment, the financial planning system 160 retrieves further information regarding a user's finances based on information input into the interface. For example, the financial planning system 160 may generate an interface for receiving user account information, such as account login information or information about the third party system such as a name, the type of data the system offers (e.g., credit, debt, retirement, identity theft, credit score), a uniform resource identifier (e.g., uniform resource locator), or other data to facilitate connecting to and processing data from the third party servers 140. For example, a user may input a credit card and account number, and the financial planning system 160 may then retrieve information about the credit card account, such as information about the balance and purchases made with the credit card. In one embodiment, the financial planning system 160 does not use scripts or screenshots to aggregate information from multiple sources.

In one embodiment, the financial planning system 160 uses screen scrapes to obtain information about the user's finances. For example, the financial planning system 160 may receive a user's account information, such as a username and password, for an account at a financial institution, and the financial planning system 160 may then retrieve information from the financial institution's website using screen scrapes. In another embodiment, the financial planning system 160 accesses the third party servers 140 through a remote interface. The financial planning system 160 may navigate the third party server 140 to retrieve the account data or subscribe to account activity occurring at the third party server 140. The financial planning system 160 may also listen for account activity occurring at the third party server 140. In one embodiment, the financial planning system 160 stores the retrieved data and data input by the user in the database 164.

Continuing to a block 204, the financial planning system 160 processes the data received from the financial accounts. Processing the data may involve calculations that include categorizing, summarizing, or aggregating the data. In one embodiment, the data is aggregated in a specific manner based on the individual source of the financial information such that the same information processing is not used for all financial institutions. In one embodiment the data is categorized, summarized, or aggregated to display information to a user about the user's current debt and possible methods of debt elimination. The data can be analyzed before it is displayed to show a user their current financial situation and possible debt payoff financial scenarios.

Continuing to a block 206, the financial planning system 160 generates an interface for displaying the processed data. In one embodiment, after aggregating information from multiple sources, the financial planning system 160 generates an interface to display information from the multiple sources on a single interface. The financial planning system 160 generates an interface to display the financial data to the user in a manner that allows the user to view a comprehensive view of his financial situation. The interface may show multiple accounts virtually side by side. The interface may display, for example, all of the user's financial information at once on one screen. This allows a user to interact with all their financial information on one screen. The interface may also display the user's financial information in multiple pages that the user can view separately. The interface may allow a user to make financial decisions based on a full view of his financial situation and may include information aggregated from multiple financial sources. The interface may display a variety of processes financial data, such as a summary chart of the user's income and expenses. The interface may further include a listing of all of the user's financial transactions for the month, including those gathered by the financial planning system from other websites. The interface may be updated continually, on demand, or at designated times. Further, the interface may be customizable to allow a user to view only certain information. The financial planning system 160 may further notify a user when financial information may be tax deductible. This tax deductible information can be organized into a report or spreadsheet and used to aid in tax preparation and available on the interface or download.

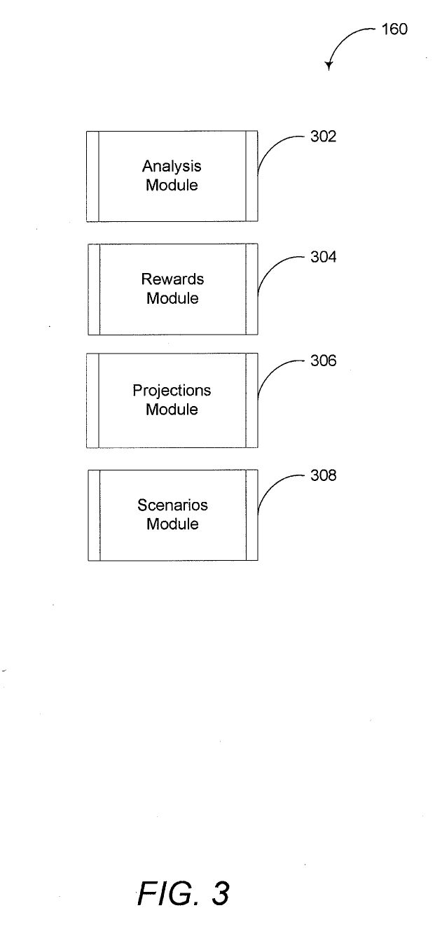

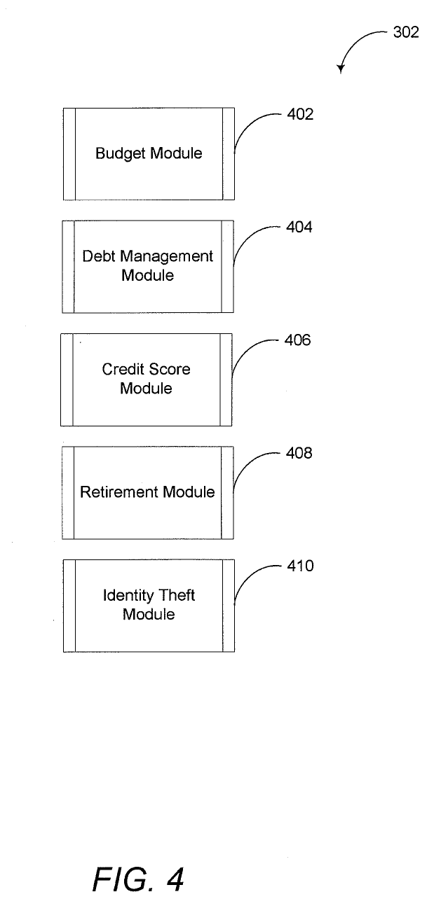

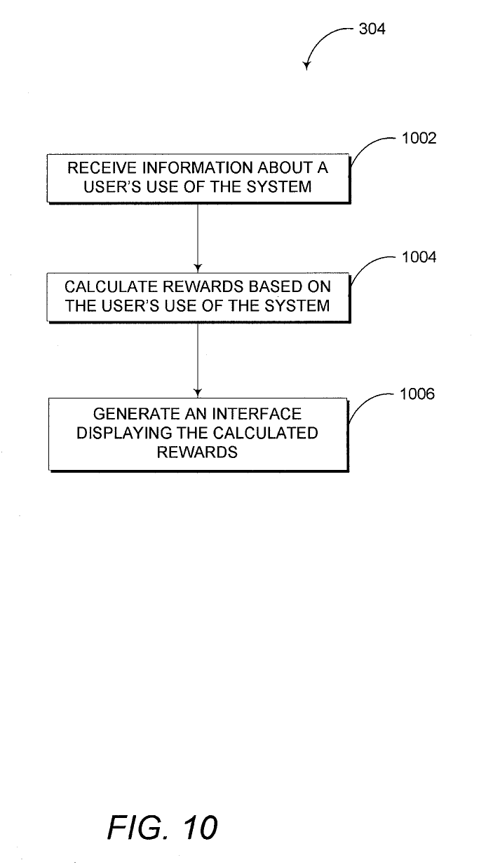

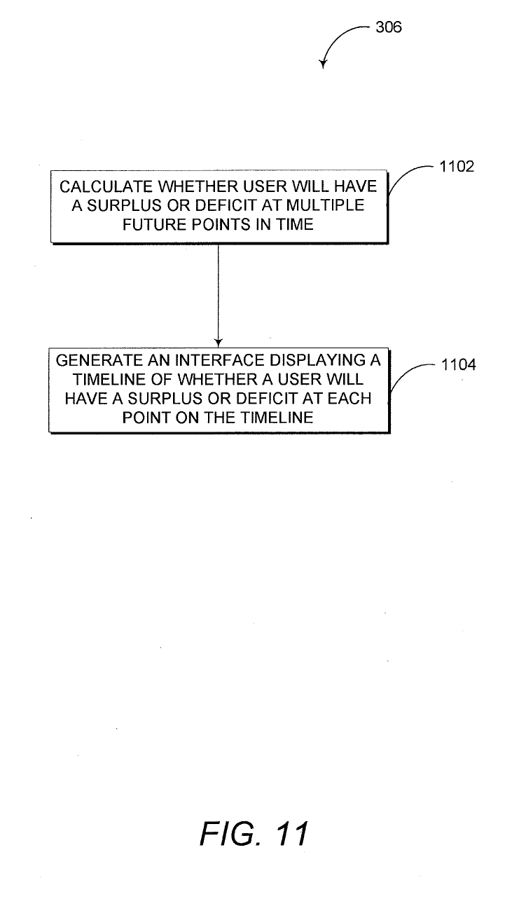

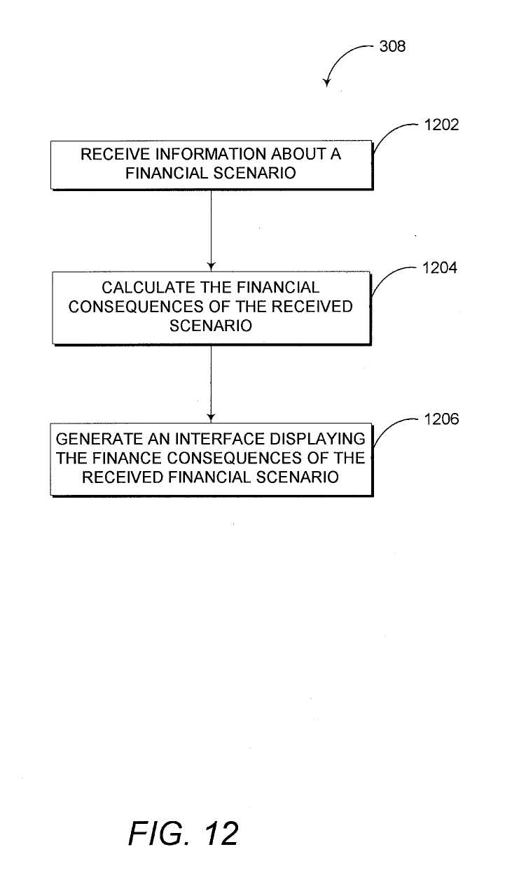

FIG. 3 is a block diagram illustrating modules of the financial planning system 160. The modules include an analysis module 302 described in further detail in FIGS. 4-9, a rewards module 304 described in further detail in FIG. 10, a projections module 306 described in further detail in FIG. 11, and a scenarios module 308 discussed in further detail in FIG. 12. The various modules process financial data and generate interfaces to display financial data to the user. The financial planning system 160 may include additional modules other than those shown in FIG. 3.

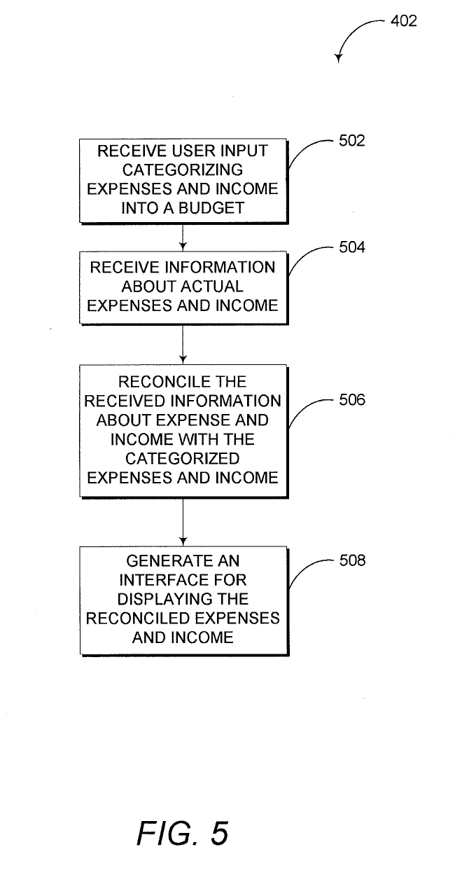

FIG. 4 is a block diagram illustrating financial planning analysis sub-modules of the analysis module 302. The financial planning system 160 may perform various types of analysis on the received data. For example, the analysis module 302 may contain sub-modules directed to different types of analysis. The sub-modules may include a budget module 402, a debt management module 404, a credit score module 406, a retirement module 408, and an identity theft module 410. The processes executed by these modules are discussed in FIGS. 5-9. The financial planning system 160 may perform other additional analysis.

FIG. 5 is a flow diagram illustrating a process performed by the analyze budget module 402 shown in FIG. 4. The financial planning system 160 may generate interfaces that allow a user to build a budget. Beginning at a block 502, the financial planning system 160 receives user input categorizing expenses and income into a budget. In one embodiment, the financial planning system 160 provides default budget categories, and in another embodiment, the financial planning system 160 allows the user to enter individual budget categories. In another embodiment, the financial planning system 160 displays financial questions to the user and based on the user's answers to the questions, the financial planning system 160 creates custom budget categories that correspond to the user's answers. For example, the financial planning system 160 may display, for example, a question about whether a user has a car loan. If the user answers that he/she has a car loan, the financial planning system 160 would generate a custom category for the car loan.

Continuing to a block 504, the financial planning system 160 receives information about a user's actual expenses and income. The interface may both retrieve information about expenses and income from the user's accounts and allow the user to enter additional information. In one embodiment, the financial planning system 160 is configured to use a logical algorithm, such as a neural network, to facilitate the identification and tracking of the expense and income data.

Continuing to a block 506, the financial planning system 160 reconciles the actual expense and income with the user's stored budget information. In one embodiment, the financial planning system 160 reconciles the actual expense and income data by comparing transaction characteristics such as amounts, dates, or payees. In one embodiment, the financial planning system 160 uses a logical algorithm to facilitate the reconciliation.

Continuing to a block 508, the financial planning system 160 generates an interface for displaying the results of the reconciliation performed in step 506. The budget interface may list categories of expenses and display a user's expenses in each category. The financial planning system 160 may then generate an interface displaying income versus expenses such that income, debts, goals, expenses, and mortgages are displayed to the user in an easy to understand format. In another embodiment, the financial planning system 160 generates an interface that allows a user to schedule payments. The financial planning system 160 may automatically execute the payments at the scheduled time and update the actual expenses and income accordingly.

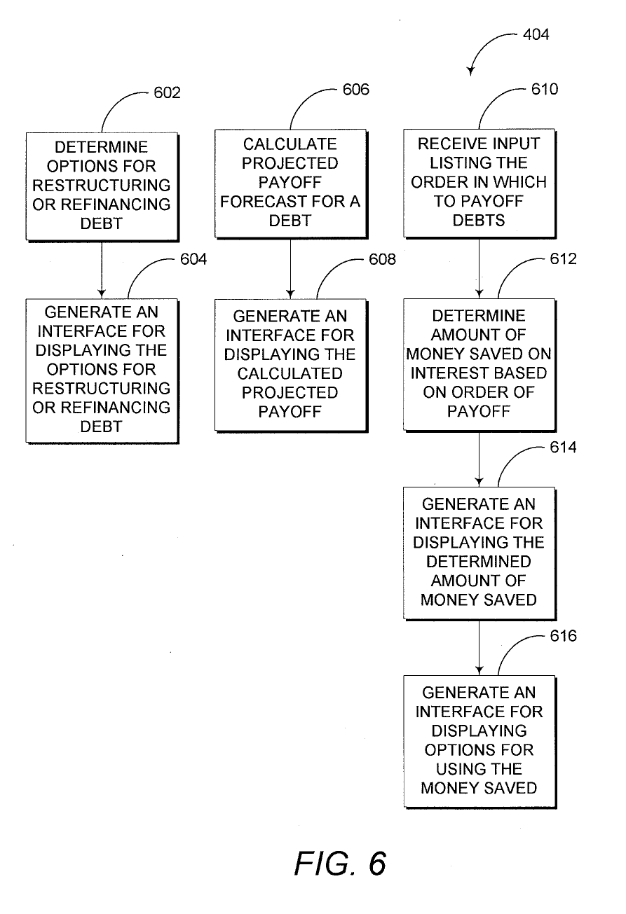

FIG. 6 is a flow diagram illustrating processes performed by the analyze debt management module 404 shown in FIG. 4. For example, the debt management module 404 may facilitate restructuring and refinancing debt. Beginning at a block 602, the financial planning system 160 determines options for restructuring or refinancing debt. In one embodiment, the options are determined based, in part, on the user's tracked data or the user's credit score. In one embodiment, the financial planning system 160 receives the options from third party servers 140 continuously, on demand, or on a schedule. In one embodiment, the financial planning system 160 generates the options from a series of elements that may be stored locally or retrieved from one or more third party servers 140. The options for restructuring or refinancing debt may take into account all of the user's debt. For example, the system may take into account the interest rates on some or all of the user's various debt (e.g., credit card, auto loan, student loan, mortgage, etc.) and determine the most effective way to pay off the user's debt. The debt payoff option can allow the user to maintain the same standard of living, if desired, and continue paying the same monthly amount towards debt both before and after the restructuring or refinancing.

Moving to a block 604, the financial planning system 160 generates an interface for displaying the determined options for restructuring or refinancing debt. In one embodiment, the financial planning system 160 generates an interface providing the user options for short-term emergency loans to help the user save interest and more quickly pay off debt. In one embodiment, the financial planning system 160 receives input from the user selecting a restructuring or refinancing option. The financial planning system 160 may transfer data in response to the received user input to facilitate the refinancing or restructuring of debt. The financial planning system 160 may also determine and generate an interface to display the consequences of accepting the displayed short-term loan, refinancing, or restructuring options.

The debt management module 404 may help calculate and display information about projected debt payoff. For example, beginning at a block 606, the financial planning system 160 calculates projected payoff forecast for a debt. In one embodiment, the calculations are based on a user's debt data received from third party servers 140. In another embodiment, the debt data is received from a user device 150. The financial planning system 160 calculates a projected payoff forecast. In one embodiment, the projected payoff forecast is based in part on the payoff list, debt amount, interest rates, and interest calculation method. The payoff chart may indicate the projected payoff, normal payoff, consumer debts, and MCA. The interface may also include a freedom chart indicating when a user will be free from debts that displays projected payoff, normal payoff, consumer debts, and savings. Continuing to a block 608, the financial planning system 160 generates an interface to display the projected payoff calculated at block 606. The interface may show the debt payoff forecast for multiple debts or a single debt. The interface may be a chart or a timeline displaying the payoff date for each debt. In one embodiment, the financial planning system generates an interface displaying a chart made through the context of interest savings on a person's payoff chart.

The debt management module 404 may further generate an interface that allows a user to choose to payoff a particular debt more quickly in order to save money on interest. Beginning at a block 610, the financial planning system 160 receives input listing the order in which to pay off debts. Continuing to a block 612, the financial planning system 160 determines an amount of money saved on interest based on the order of debt payoff. For example, the savings on interest may be savings from mortgage or consumer debt interest. Moving to a block 614, the financial planning system 160 generates an interface for displaying the determined amount of money saved. The debt management module 404 may also display how much interest that user is paying each month by not following a debt payoff plan.

Proceeding to a block 616, the financial planning system 160 generates an interface for displaying the amount of money saved on interest and displaying options for using the money saved on interest payment. For example, the options may include paying off other debt, such as mortgage or consumer debt, paying for life insurance, paying for business debt, or paying for a retirement vehicle. Further, options may include ways to invest the money that would have been paid in interest and display the potentially earning to the user. In one embodiment, the financial planning system 160 then receives a selection from the user and implements the user's selection for the interest savings. The various processes performed by the debt management module 404 may be used together. For example, a user could first change the payoff order of debts and then view an updated project payoff chart. In one embodiment, the financial planning system 160 uses projected interest savings to sell affiliate products. For example, the financial planning system 160 may calculate and display the interest that may be saved by switching products, such as credit cards.

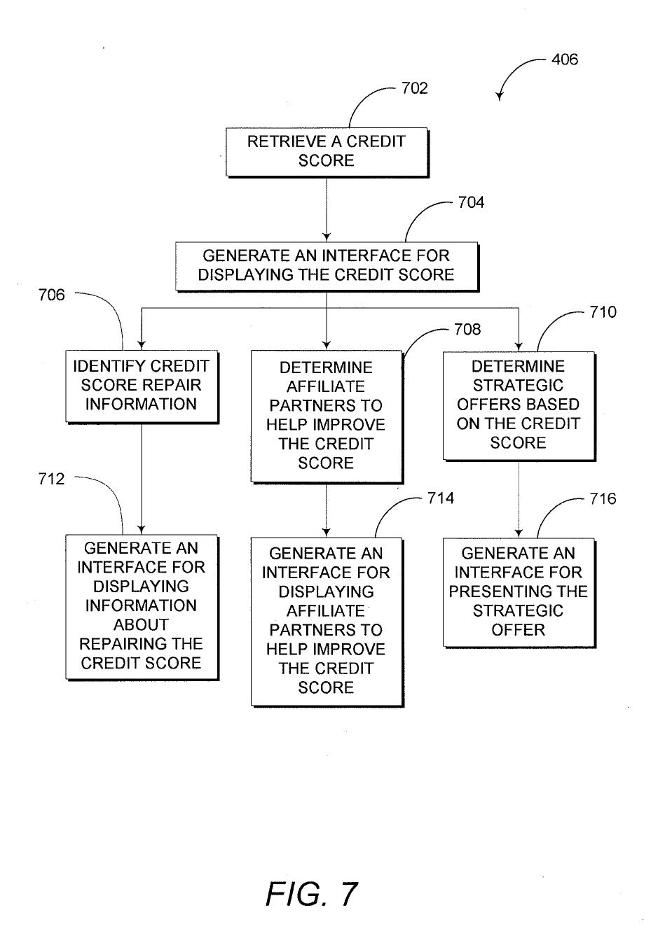

FIG. 7 is a flow diagram illustrating a process performed by the analyze credit score module 406 shown in FIG. 4. In one embodiment, the financial planning system 160 allows a user to monitor and repair his credit score. Beginning at a block 702, the financial planning system 160 retrieves a credit score for the particular user. In one embodiment, the credit score determination is accomplished by the financial planning system 160 using, in part, stored user data. In another embodiment, the financial planning system 160 receives data from the third party servers 140, such as a credit reporting agent server, to determine the credit score. Continuing to a block 704, the financial planning system 160 generates an interface for displaying the credit score. In one embodiment, the generation process can include reformatting or restructuring the credit score information. The financial planning system 160 may then facilitate repairing the credit score, identifying affiliate partners to facilitate repairing the credit score, and determining offers based on the credit score.

Proceeding to a block 706, the financial planning system 160 identifies credit score repair information. In one embodiment, the credit score repair information is static information. In another embodiment, the financial planning system 160 generates credit score repair information based at least in part on the user's characteristics or market conditions. In one embodiment, the credit repair information is received from third party servers 140 continuously, on demand, or on a schedule. Moving to a block 712, the financial planning system 160 generates an interface to display information about repairing the credit score. The financial planning system 160 may receive input from a user device 150 selecting repair option exercise and automatically performs the selected credit repair option.

In another embodiment, the financial planning system 160 helps a user to repair or improve his credit score by connecting the user with affiliate partners. At a block 708 the financial planning system 160 determines affiliate partners to help improve the credit score. In one embodiment, the financial planning system 160 determines the available affiliate partners by using third party servers 140. In another embodiment, the financial planning system determines the available affiliate partners from a locally stored, pre-defined list, such as a list of partners stored in the database 164. The available affiliate partners may be based, for example, on the geographic location of the user or the user's spending history. Continuing to a block 714 the financial planning system 160 generates an interface for displaying affiliate partner data to help improve the credit score. Affiliate partner data can include, for example, contact information, promotional information, or marketing materials. In one embodiment, the financial planning system 160 receives input from the user device 150 selecting one or more of the affiliate partners, and then, the financial planning system 160 connects the user with the affiliate, such as by sending an email or opening a web browser to the affiliate's web page.

In one embodiment, the financial planning system determines strategic offers for the user based on the user's credit score and generates an interface displaying the strategic offers to the user. At a block 710 the financial planning system 160 determines one or more strategic offers based on the credit score. In one embodiment, the strategic offers are determined in part on an analysis of the user financial data input into the financial planning system 160. In another embodiment, the financial planning system 160 determines the strategic offers by sending user data to third party servers 140 and receiving the strategic offers from the third party servers 140. In another embodiment, the financial planning system 160 determines the strategic offers based on the user's credit score and spending. For example, a strategic office for a home refinancing will only be displayed to a user with a home mortgage, and a car insurance offer will only be displayed to a user who owns a car. The strategic offer could be, for example, an offer for a new credit card with a particular APR. Proceeding to a block 716, the financial planning system 160 generates an interface for making one or more strategic offers. In one embodiment, the financial planning system 160 receives input from the user accepting one of the offers and executes the particular offer. The financial planning system 160 may also generate an interface to display the financial consequences of accepting one or more of the strategic offers.

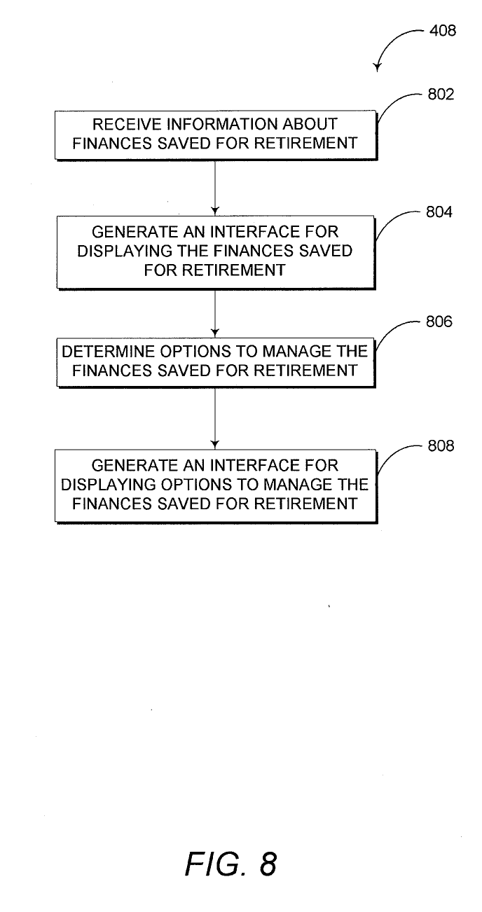

FIG. 8 is a flow diagram illustrating a process performed by the retirement analysis module 408 shown in FIG. 4. Beginning at a block 802, the financial planning system 160 receives information about finances saved for retirement. The data relevant to retirement finances includes, for example, an amount of money saved for retirement or a projected amount of interest or income that will be received from money saved for retirement. In one embodiment, the data is received from the third party servers 140 associated with a variety of sources, such as securities brokers, banks, insurance companies, or trust administrators. In another embodiment, the data is received from the user device 150. For example, the user may directly enter information about retirement savings. Continuing to a block 804, the financial planning system 160 generates an interface for displaying finances saved for retirement. In one embodiment, the financial planning system 160 calculates how much a user has saved for retirement and displays the total amount saved for retirement. In another embodiment, the financial planning system 160 calculates and displays how much a user will have saved for retirement at a point in the future.

Moving to a block 806, the financial planning system 160 determines options to manage the finances saved for retirement. The options may be determined, for example, in part on an analysis of the user data by the financial planning system. The options may also be determined by sending user data to a third party and receiving the options from the third party. The options may be, for example, stocks or bonds. Proceeding to a block 808, the financial planning system 160 generates an interface for displaying options to manage the finances saved for retirement. In one embodiment, the options displayed are the options determined at the block 806. In one embodiment, the interface generated by the financial planning system 160 allows a user to select one of the displayed options, and the financial planning system 160 automatically transfers the user's money according to the selected option.

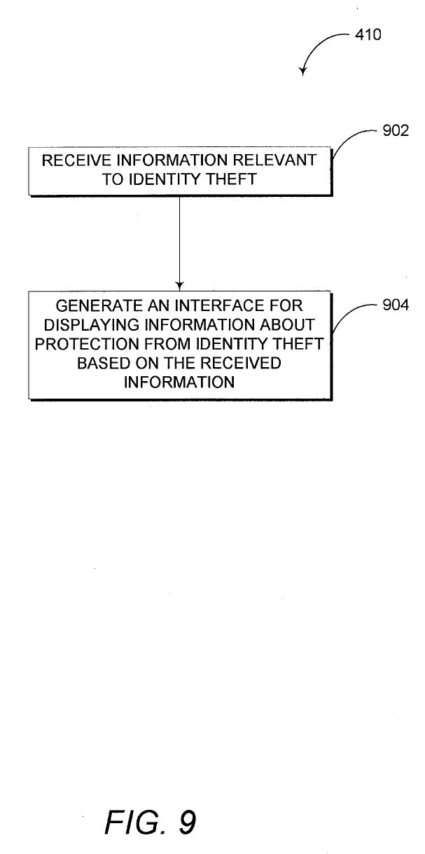

FIG. 9 is a flow diagram illustrating a process performed by the analyze identity theft module 410 shown in FIG. 4. In one embodiment, the financial planning system 160 partners with affiliates that help protect against identify theft, for example by monitoring suspicious financial activity. The financial planning system may then generate an interface that provides alerts and information to the user regarding potential identity theft. Beginning at a block 902, the financial planning system receives information relevant to identity theft. In one embodiment, the data is received from the third party servers 140 from various third parties, such as a credit reporting agency, an identity protection service, or a financial institution. In another embodiment, the identity theft data is received from the user device 150. The financial planning system 160 may then determine whether it is likely that the user is a victim of identity theft based on its own algorithms or based on a response from a third party server 140. Moving to a block 904, the financial planning system 160 generates an interface for displaying information about protection from identity theft based on the received information.

FIG. 10 is a flow diagram illustrating a process performed by the rewards module 304 shown in FIG. 3. In one embodiment, the financial planning system 160 provides a sales tool and revenue sharing platform. For example, the financial planning system 160 may generate an interface for rewards shopping. In another embodiment, the financial planning system 160 provides a sales tool used to sell affiliated products. Beginning at a block 1002, the financial planning system 160 receives information about a user's use of the financial planning system 160. The information may include, for example, system usage data, financial data, custom user data, and other data provided by the user. In one embodiment, the data is stored in the database 164. In one embodiment, the financial planning system 160 stores information about system usage as the system is used. In another embodiment, the financial planning system 160 stores information about the user's system usage after each action or during each action.

Moving to a block 1004, the financial planning system 160 calculates rewards based on the user's use of the financial planning system 160. In one embodiment, the financial planning system 160 provides one or more rewards based, at least in part, on the information obtained at block 1002. The financial planning system 160 may give a user incentive awards points based on certain actions, such as maintaining an account with the financial planning system for a certain period of time, shopping with particular retailers, or making certain strategic moves with affiliate partners.

In one embodiment, rewards can be discounts, incentives, free products, or information. The financial planning system 160 may provide an incentive for online shopping based on interest savings, such as interest savings from mortgage or consumer debt. In another embodiment, the financial planning system 160 gives a user cash back, such as through online shopping incentives and strategic savings and smart moves (e.g., incentives for switching financial products such as credit cards), for using the financial planning system 160. In one embodiment, the financial planning system 160 tracks a user's purchases of affiliate products and purchases with rewards points. The information may then be used to share revenue between the financial planning system 160 and affiliate products and vendors.

In one embodiment, the financial planning system 160 provides rewards that may be used for paying down a user's debt or interest on debt. For example, the financial planning system 160 may provide rewards that may be used to help pay off short-term emergency “pay-day” loans or other debt. Because short-term emergency loans often have a high interest rate, this may help the user decrease his interest payments.

In one embodiment, the financial planning system 160 saves the rewards for the user. In another embodiment, the rewards are time sensitive, expiring after a predefined period. The rewards may be preloaded to the financial planning system 160, or the financial planning system 160 may be receive rewards information from the third party servers 140 in continuously, on demand, or on schedule.

Continuing to a block 1006, the financial planning system 160 generates an interface displaying the provided rewards. The interface may display, for example, a list of categories of retailers and a list of retailers under each category. The interface may further display the amount of rewards points required to equal a dollar of savings from the particular retailer. In another embodiment, the financial planning system 160 generates an interface that displays vendors that provide discounts to users of the financial planning system. In one embodiment, the financial planning system 160 enables the reception of input from a user device 150 to select a reward, and the financial planning system 160 facilitates the delivery of the reward, such as through an online purchase. Further, the financial planning system 160 may allow reward points to be deposited directly into a user's account at a financial institution. For example, the reward points may be converted to a dollar amount and deposited into a user's checking account.

FIG. 11 is a flow diagram illustrating a process performed by the projections module 306 shown in FIG. 3. In one embodiment, the financial planning system 160 uses received financial information from a variety of sources to calculate future financial information. For example, the financial planning system 160 may generate an interface that illustrates the interest and interest savings impact of financial decisions. Beginning at a block 1102, the financial planning system 160 calculates whether the user will have a surplus or a deficit at multiple points in the future. The calculation may be based on information received from third party servers 140 and information received from the user device 150.

Proceeding to a block 1104, the financial planning system 160 then generates an interface displaying a timeline of whether a user will have a surplus or deficit at each point on the timeline. In one embodiment, the financial planning system 160 generates an interface that illustrates a projected hypothetical future payoff date of a user's debt from multiple sources. In one embodiment, the financial planning system 160 displays the future financial information in a graphical manner other than a timeline.

FIG. 12 is a flow diagram illustrating a process performed by the scenarios module 308 shown in FIG. 3. Beginning at a block 1202, the financial planning system 160 receives information about a financial scenario. In one embodiment, the financial tracking interface generates an interface to allow the user to enter financial scenarios. In another embodiment, the financial tracking interface generates an interface that allows the user to enter financial scenarios in a question and answer format. Continuing to a block 1304, the financial planning system 160 then calculates the financial consequences of the received scenario. Moving to a block 1306, the financial planning system 160 generates an interface displaying the finance consequences of the received financial scenario. In one embodiment, the financial planning system generates an interface displaying the user's future financial position based on the user's financial decisions, such as decisions about retirement, debt, and payments of expenses. In another embodiment, the financial planning system 160 generates a side-by-side comparison of the user's current budget and financial plan and the financial plan based on the financial scenario. Scenarios module 308 allows a user to make changes to their current budget and see visual depictions of the consequences of the financial scenario. For example, a user may enter a financial scenario of spending $40/month on a purchase. The financial planning system may display that the decrease in disposable income will increase the amount of time it will take to pay off debt and the additional money that will be spent in interest or how the purchase could affect retirement savings.

In one embodiment, the financial planning system 160 generates financial scenarios tailored to the particular user. For example, the financial planning system 160 may calculate savings based on potential products. The financial planning system 160 may generate an interface that suggests smart financial moves and displays the amount of savings. The interface may for example display “switch to Company A from Company B and save $Y per month, totaling $Z saved in interest off of your total debt.” In one embodiment, the affiliate products relate to the user's expenses, such as possible savings by switching cable or phone service providers. The smart financial moves may be general or based on the user's location, credit score, account information or spending history. The smart financial moves may also be used to build institution loyalty. For example, a user who banks at a specific bank or credit union will only be shown offers that pertain to the specific institution.

In one embodiment, the financial planning system 160 is tailored for people with disabilities. Persons with disabilities are a protected class of consumer, and they are also protected under federal fair housing laws. In another embodiment, the financial planning system 160 is tailored for personal or business finances.

The financial planning system 160 may have additional application, such as mobile applications and notifications, email, social network applications, and Twitter applications. For example, a user may be able to check account balances using twitter private messaging, and a social networking application, such as a Facebook application, may allow the user to compare or compete on money savings with friends. In one embodiment, the additional applications are software widgets. The financial planning system 160 may also include a web browser plug-in that is used to track a user's spending anywhere on the network 102 and locate money saving offers for the user based on the user's spending. These offers may be presented to the user by the financial planning system 160 while the user is on the network 102.

The financial planning system 160 may include a telephone interaction system that allows the user to call a number and receive account information for multiple accounts from multiple sources. This would allow the user to avoid calling multiple financial institutions or checking the websites of multiple financial institutions. The financial planning system 160 may also provide that same functionality over email or twitter. In one embodiment, the financial planning system 160 may send an automated phone call, email, or other message to notify of changes in a user's financial situation, to provide reminders, to notify the user of updated financial offers, and to notify a user about upcoming events, such as scheduled payments. The financial planning system 160 may generate an interface with additional financial planning tools, such as loan calculators, interest rate comparisons, and P&FVA. The financial planning system 160 may generate an interface that presents an online financial library.

In view of the above, one will appreciate that the developed embodiments overcome the difficulty of understanding a complicated financial situation. For example, embodiments provide a comprehensive view of a financial situation.

Those of skill will recognize that the various illustrative logical blocks and algorithm steps described in connection with the embodiments disclosed herein may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present development.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

In at least some of the aforesaid embodiments, any element used in an embodiment can interchangeably be used in another embodiment unless such a replacement is not feasible. It will be appreciated that the steps of the methods described above can be combined, divided, or omitted or that additional steps can be added. It will also be appreciated by those skilled in the art that various other omissions, additions and modifications may be made to the methods and structures described above without departing from the scope of the embodiments.

For purposes of this disclosure, certain aspects, advantages, and novel features of the embodiments are described herein. It is to be understood that not necessarily all such advantages may be achieved in accordance with any particular embodiment. Thus, for example, those skilled in the art will recognize that some embodiments may be embodied or carried out in a manner that achieves one advantage or group of advantages as taught herein without necessarily achieving other advantages as may be taught or suggested herein.

The herein described subject matter sometimes illustrates different components contained within, or connected with, different other components. It is to be understood that such depicted architectures are merely illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While the above detailed description has shown, described, and pointed out novel features of the development as applied to various embodiments, it will be understood that various omissions, substitutions, and changes in the form and details of the device or process illustrated may be made by those skilled in the art without departing from the spirit of the development. As will be recognized, the present development may be embodied within a form that does not provide all of the features and benefits set forth herein, as some features may be used or practiced separately from others. The scope of the development is indicated by the appended claims rather than by the foregoing description. All changes which come within the meaning and range of equivalency of the claims are to be embraced within their scope.

What is claimed is:

1. A system for managing financial information, comprising:
a processor configured to:
receive data associated with a plurality of financial accounts;
process the data, wherein processing comprises one of categorizing, summarizing, or aggregating; and
generate an interface displaying the processed data.

2. The system of claim 1, wherein receiving data associated with a plurality of financial accounts comprises:
receiving login information associated with a plurality of accounts; and
retrieving data from the plurality of financial accounts using the login information.

3. The system of claim 1, wherein receiving data associated with a plurality of financial accounts comprises receiving information from a financial institution.

4. The system of claim 1, wherein the method for processing the data is dependent on the source of the financial information.

5. The system of claim 1, wherein the processor is further configured to:
receive user input categorizing expenses and income into a budget;
receive actual expenses and income;
reconcile the actual expenses and income with the categorized expenses and income; and
generate an interface for displaying the reconciled expenses and income.

6. The system of claim 1, wherein the processor is further configured to:
calculate a projected payoff forecast for a debt; and
generate an interface for displaying the calculated projected payoff.

7. The system of claim 1, wherein the processor is further configured to:
determine options for restructuring or refinancing a debt; and
generate an interface for displaying the determined options for restructuring or refinancing the debt.

8. The system of claim 1, wherein the processor is further configured to:
receive input listing the order in which to payoff debts;
determine the amount of money saved on interest based on the order of payoff;
generate an interface for displaying the determined amount of money saved; and
generate an interface for displaying options for using the money saved.

9. The system of claim 1, wherein the processor is further configured to:
retrieve a credit score; and
generate an interface for displaying the credit score.

10. The system of claim 9. wherein the processor is further configured to:
identify credit repair information; and
generate an interface for displaying information about repairing the credit score.

11. The system of claim 9, wherein the processor is further configured to:
determine one or more strategic offers based on the credit score; and
generate an interface for presenting one or more strategic offers.

12. The system of claim 1, wherein the processor is further configured to:
identify affiliate partners to help improve a credit score; and
generate an interface for displaying the affiliate partners.

13. The system of claim 1, wherein the processor is further configured to:
provide rewards based on use of the system; and
generate an interface for displaying the provided rewards.

14. The system of claim 1, wherein the processor is further configured to:
receive information relevant to identity theft; and
generate an interface for displaying information about protection from identity theft based on the received information.

15. The system of claim 1, wherein the processor is further configured to:
receive information about finances saved for retirement;
generate an interface for displaying the finances saved for retirement;
determine options for managing the finances saved for retirement; and
generate an interface for displaying options for managing the finances saved for retirement.

16. The system of claim 1, wherein the processor is further configured to:
calculate whether a user will have a surplus or deficit at multiple future points in time; and
generate an interface for displaying a timeline of whether a user will have a surplus or deficit at each point on the timeline.

17. The system of claim 1, wherein the processor is further configured to:
receive information about a financial scenario;
calculate the financial consequences of the received scenario; and
generate an interface for displaying the financial consequences of the received financial scenario.

18. A method for managing financial information, comprising:
receiving data associated with a plurality of financial accounts;
processing the data, wherein processing comprises one of categorizing, summarizing, or aggregating; and
generating an interface displaying the processed data.

19. The method of claim 18, wherein receiving data associated with a plurality of financial accounts comprises:
receiving login information associated with a plurality of accounts; and
retrieving data from the plurality of financial accounts using the login information.

20. The method of claim 18, wherein receiving data associated with a plurality of financial accounts comprises receiving information from a financial institution.

21. A system for managing financial information, comprising:
means for receiving data associated with a plurality of financial accounts;
means for processing the data, wherein processing comprises one of categorizing, summarizing, or aggregating; and
means for generating an interface displaying the processed data.

22. The system of claim 21, wherein receiving data associated with a plurality of financial accounts comprises:
means for receiving login information associated with a plurality of accounts; and
means for retrieving data from the plurality of financial accounts using the login information.

23. The system of claim 21, wherein receiving data associated with a plurality of financial accounts comprises receiving information from a financial institution.
